(19) United States
(12) Patent Application Publication
(10) Pub. No.: US 2019/0095259 A1
(43) Pub. Date: Mar. 28, 2019

(54) Electronic Device and Log Application

(71) Applicant: Kyocera Document Solutions Inc., Osaka (JP)

(72) Inventor: Hiroshi Nakamura, Osaka (JP)

(21) Appl. No.: 16/128,536

(22) Filed: Sep. 12, 2018

(30) Foreign Application Priority Data
Sep. 26, 2017 (JP) 2017-185087

(51) Int. Cl. G06F 9/54; G06F 17/30

(52) U.S. Cl. CPC G06F 9/542; G06F 17/30144; G06F 9/541

(57) ABSTRACT

An electronic device includes a recording medium that stores a log application for storing a log of changes of an internal state in the electronic device and changes of an API call as a calling of the API by the application. The changes of the internal state and the changes of the API call are classified in a plurality of categories. The log application causes the electronic device to achieve a log storage unit. The log storage unit stores the changes of the internal state and the changes of the API call as the log. The changes of the internal state and the changes of the API call are notified by the change notification unit. The log storage unit stores the changes of the internal state and the changes of the API call of only one category among the plurality of categories as the log.

### INCORPORATION BY REFERENCE

This application is based upon, and claims the benefit of priority from, corresponding Japanese Patent Application No. 2017-185087 filed in the Japan Patent Office on Sep. 26, 2017, the entire contents of which are incorporated herein by reference.

### BACKGROUND

Unless otherwise indicated herein, the description in this section is not prior art to the claims in this application and is not admitted to be prior art by inclusion in this section.

Electronic devices typified by including a platform providing an application program interface (API) that a device application calls are known. Installing such applications in the electronic device extends its functionality to provide a user with, for example, more convenient and more easy-to-use functions. While the platform is provided by the manufacturer of the electronic device, applications are provided not only by the manufacturer of the electronic device but also by third parties in some cases.

It is preferred that such applications are created to appropriately use the API provided by the platform. In practice, however, there are applications that do not use the API appropriately, giving rise to failure.

Scenarios where an API not being appropriately used leads to failure include, for example, scenarios where the API is called when the electronic device's internal status is in a state where the API cannot be appropriately handled, and scenarios where the API is called for a purpose different from its original purpose.

Scenarios where an API is called when the electronic device's internal status is in a state where the API cannot be appropriately handled include, for example, a scenario where an API for a login process is newly called while the electronic device is in a state where the login-process API has already been called, causing the login process to be underway. When for example an API is called while the electronic device's internal status is in a state where the API cannot be appropriately handled, the electronic device's processing enters into an inappropriate loop, freezing the device's screen as it is displaying, which can halt the device's operation.

Scenarios where an API is called for a purpose different from its original purpose include, for example, a scenario where an API to delete information on a job is called with respect to a job being executed, despite it originally being necessary for a job-halting API to be called so as to stop the job being executed. While a job being executed halts because information on the job has been deleted even as an API to delete the information on the job is called with respect to the job being executed, a failure such as a log of the job not being appropriately saved sometimes occurs.

As an electronic device including a platform that runs applications, the following image processing apparatus is known. This image processing apparatus includes an operating system (OS) that runs applications. When an error occurs during execution of an application, the image processing apparatus dynamically generates a trace program corresponding to the occurring error, and with the trace program obtains necessary history information from the application in execution to store the information.

### SUMMARY

An electronic device according to one aspect of the disclosure includes a platform that provides an application program interface (API). The API is called by an application. The electronic device includes a recording medium that stores a log application that stores a log of changes of an internal state in the electronic device and changes of an API call as a calling of the API by the application. The platform causes the electronic device to achieve a change notification unit. The change notification unit notifies the log application of the changes of the internal state and the changes of the API call. The changes of the internal state and the changes of the API call are classified in a plurality of categories. The log application causes the electronic device to achieve a log storage unit. The log storage unit stores the changes of the internal state and the changes of the API call as the log. The changes of the internal state and the changes of the API call are notified by the change notification unit. The log storage unit stores the changes of the internal state and the changes of the API call of only one category among the plurality of categories as the log.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a block diagram illustrating an MFP according to one embodiment of the disclosure.

FIG. 2 illustrates operations of the MFP according to the one embodiment when a change of an internal state in the MFP is stored as a log.

FIG. 3 illustrates operations of the MFP according to the one embodiment when a change of an API call is stored as a log.

FIG. 4 illustrates an information flow in the MFP according to the one embodiment when the API call performed by an application is not under the category indicated in log-target-category information.

FIG. 5 illustrates an information flow in the MFP according to the one embodiment when the API call performed by an application is under the category indicated in the log-target-category information.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes one embodiment of the disclosure with reference to the drawings.

First, the following describes a configuration of a multifunction peripheral (MFP) 10 as an electronic device according to an embodiment.

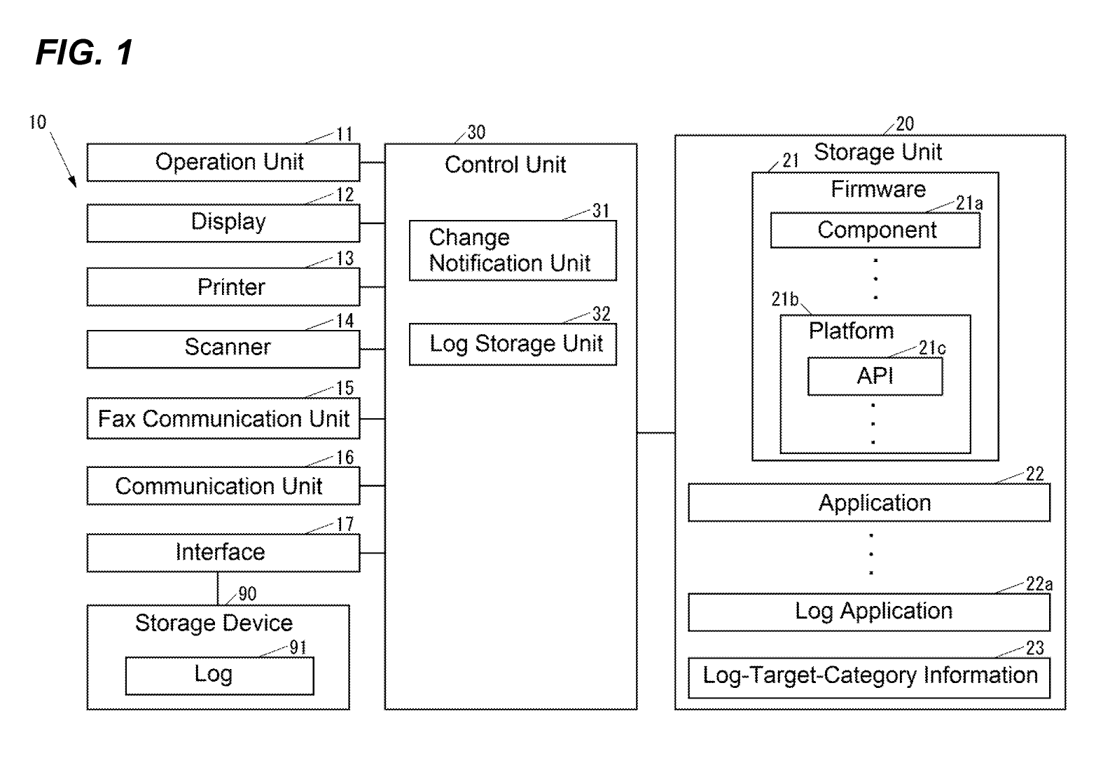

FIG. 1 illustrates a block diagram illustrating the MFP 10 according to the embodiment.

As illustrated in FIG. 1, the MFP 10 includes an operation unit 11, a display 12, a printer 13, a scanner 14, a fax communication unit 15, a communication unit 16, an interface 17, a storage unit 20, and a control unit 30. The operation unit 11 is an input device such as a button through which various operations are input. The display 12 is a display device such as a liquid crystal display (LCD) that displays various kinds of information. The printer 13 is a print device that prints an image on a recording medium such as a paper sheet. The scanner 14 is a reading device that reads an image from an original document. The fax communication unit 15 is a fax device that performs fax communication with an external facsimile device (not illustrated) via a communication line such as a dial-up line. The communication unit 16 is a communication device that communicates with an external device via a network such as a local area network (LAN) and Internet or directly by a wired communication or a wireless communication without via the network. The interface 17 is connected to a storage device 90 outside the MFP 10, such as an SD card and a universal serial bus (USB) memory. The storage unit 20 is a non-volatile storage device such as a semiconductor memory and a hard disk drive (HDD) that store various kinds of information. The control unit 30 controls the entire MFP 10.

The storage device 90 connected to the interface 17 is configured to store changes of an internal state in the MFP 10 and changes of an API call as an application program interface (API) (described below) calling, which is performed by an application (described below), as a log 91.

Hereinafter, the changes of the internal state in the MFP 10 and the changes of the API call are referred to as log information. The log information is classified in a plurality of categories, such as a login-related category that is related to a login to the MFP 10, a job-execution-related category that is related to executing a job by the MFP 10, and a sleep-related category that is related to a sleep function of the MFP 10.

The storage unit 20 stores a firmware 21. The firmware 21 may be installed in the MFP 10 at production stage of the MFP 10, may be additionally installed in the MFP 10 from an external storage medium such as a USB flash drive, and may be additionally installed in the MFP 10 from the network.

The firmware 21 includes components 21a for respective functions of the MFP 10, such as a component for a FAX function that performs a FAX transmission and a FAX reception via the fax communication unit 15, a component for a print function that prints an image on a recording medium based on print data by the printer 13, and a component for a sleep function where at least a part of a power supply of the MFP 10 is turned off under a specific condition.

The firmware 21 includes a platform 21b for operating an application (described below). The platform 21b includes various APIs 21c for using the components 21a.

The storage unit 20 is configured to store various applications 22 that operate on the platform 21b. The application 22 also includes a log application 22a for storing the log 91. The application 22 may be installed in the MFP 10 at production stage of the MFP 10, may be additionally installed in the MFP 10 from an external storage medium such as a USB flash drive, and may be additionally installed in the MFP 10 from the network.

The storage unit 20 is configured to store log-target-category information 23 indicating a category of log information of a target to be stored as the log 91, for each log application 22a.

The control unit 30 includes, for example, a central processing unit (CPU), a read-only memory (ROM), and a random-access memory (RAM). The ROM stores programs and various kinds of data. The RAM is used as a work area of the CPU. The CPU executes the programs stored in the ROM or the storage unit 20.

The control unit 30 executes the platform 21b, which achieves a change notification unit 31 that notifies the log application 22a of the changes of the internal state in the MFP 10 and the changes of the API call.

The control unit 30 executes the log application 22a to achieve a log storage unit 32. The log storage unit 32 stores the changes of the internal state in the MFP 10 and the changes of the API call, which are notified by the change notification unit 31, as the log 91. The log storage unit 32 stores the changes of the internal state in the MFP 10 and the changes of the API call of only one category among a plurality of categories as the log 91.

The following describes a concrete example of the log information of the login-related category among the plurality of categories. The changes of the internal state in the MFP 10 include, for example, a change into “a state where accepting a login request is in process,” a change into “a state where a login process is in process,” a change into “a logged-in state,” and a change into “a state where a logout process is in process.” The changes of the API call include, for example, an occurrence of a calling of the API 21c for the login process and an occurrence of a calling of the API 21c for the logout process.

The following describes a concrete example of the log information of the job-execution-related category among the plurality of categories. The changes of the internal state in the MFP 10 include, for example, a change into “a state where scanning is in process,” a change into “a state where the scanning has been completed,” a change into “a state where a FAX transmission/reception is in process,” a change into “a state where the FAX transmission/reception has been completed,” a change into “a state where copying is in process,” and a change into “a state where the copying has been completed.” The changes of the API call include, for example, an occurrence of a calling of the API 21c for generating job information, an occurrence of a calling of the API 21c for changing a job setting, such as color and monochrome, and an occurrence of a calling of the API 21c for executing a job.

The following describes a concrete example of the log information of the sleep-related category among the plurality of categories. The changes of the internal state in the MFP 10 include, for example, a change into “a state where a transition to a sleep state from an ordinary activated state is in process,” a change into “the sleep state,” a change into “a state where a transition to the ordinary activated state from the sleep state is in process,” and a change into “the ordinary activated state.” The changes of the API call include: for example, an occurrence of a calling of the API 21c for the transition to the sleep state from the ordinary activated state; and an occurrence of a calling of the API 21c for the transition to the ordinary activated state from the sleep state.

Next, the following describes operations of the MFP 10.

First, the following describes operations of the MFP 10 when the log application 22a is installed.

For example, when a failure occurs during the use of the application 22, a user of the MFP 10 requests a service person to eliminate the failure. When the service person is requested to eliminate the failure, which has occurred during the use of the application 22, by the user of the MFP 10, the service person visits an installation location of the MFP 10 to instruct an installation of the log application 22a for the category, which is necessary for eliminating the failure, from the operation unit 11. Then, the control unit 30 of the MFP 10 installs the log application 22a in the MFP 10. Here, the installation of the log application 22a in the MFP 10 causes the log storage unit 32 of the control unit 30 to store it as the log-target-category information 23 indicating the category to which the log application 22a corresponds.

After the log application 22a is installed in the MFP 10, the service person inquires of the user of the MFP 10 about the situation where the failure occurred to reproduce the situation, so as to store it as the log 91.

Next, the following describes operations of the MFP 10 when the log 91 is stored.

First, the following describes operations of the MFP 10 when the changes of the internal state in the MFP 10 are stored as the log 91.

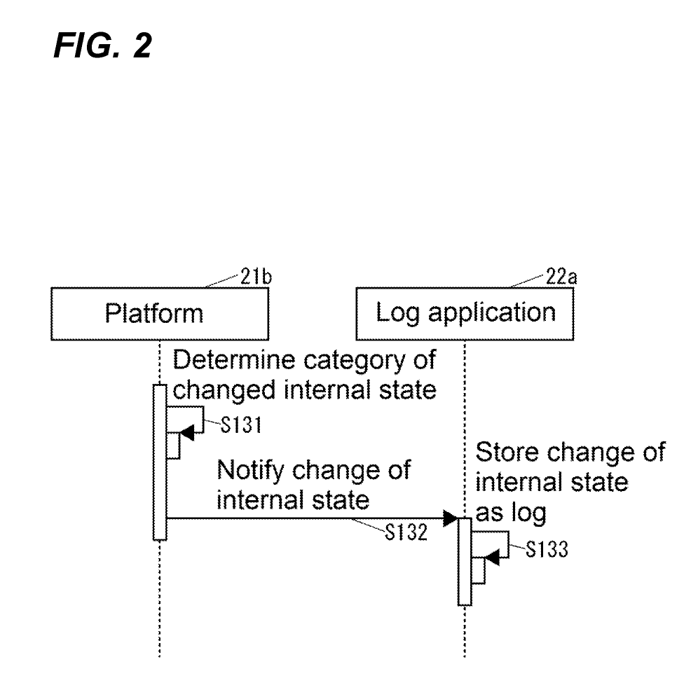

FIG. 2 illustrates the operations of the MFP 10 when the changes of the internal state in the MFP 10 are stored as the log 91.

When the internal state in the MFP 10 is changed, as illustrated in FIG. 2, the change notification unit 31 determines whether the changed internal state is under the category indicated in the log-target-category information 23 or not (Step S131).

When the changed internal state is determined to be under the category indicated in the log-target-category information 23 at Step S131, the change notification unit 31 notifies the log application 22a of this change (Step S132). That is, the change notification unit 31 performs an observer notification.

Then, the log storage unit 32 stores the changes of the internal state in the MFP 10 notified at Step S132 as the log 91 (Step S133).

When the changed internal state is not determined to be under the category indicated in the log-target-category information 23 at Step S131, the change notification unit 31 does not notify the log application 22a of this change. Thus, this change is not stored as the log 91. However, even when the change of the internal state in the MFP 10, which is not under the category indicated in the log-target-category information 23, is notified, the log storage unit 32 does not store this change as the log 91.

Next, the following describes operations of the MFP 10 when the changes of the API call are stored as the log 91.

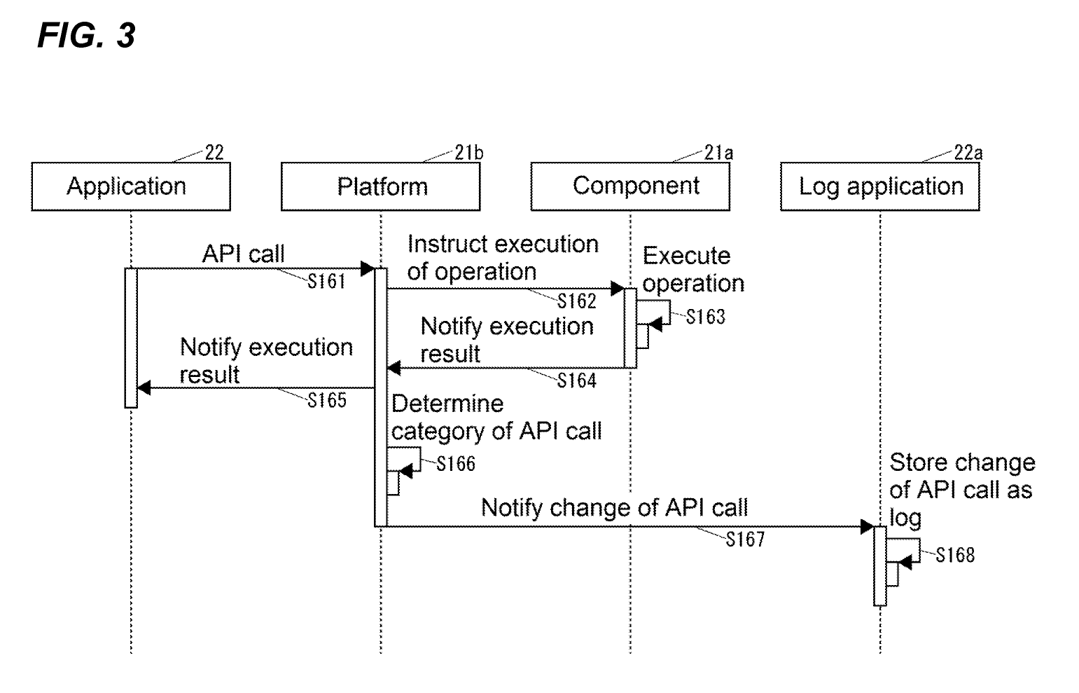

FIG. 3 illustrates the operations of the MFP 10 when the changes of the API call are stored as the log 91.

As illustrated in FIG. 3, when the application 22 performs the API call (Step S161), the platform 21b instructs the component 21a to execute an operation with the API 21c in response to the API call performed at Step S161 (Step S162).

When the component 21a executes the operation instructed at Step S162 (Step S163), the API 21c is notified of its execution result (Step S164). Then, the platform 21b notifies the application 22 of the execution result notified at Step S164 (Step S165).

When the execution result is notified at Step S164, the change notification unit 31 determines whether the API call performed at Step S161 is under the category indicated in the log-target-category information 23 or not (Step S166).

When the API call performed at Step S161 is determined to be under the category indicated in the log-target-category information 23 at Step S166, the change notification unit 31 notifies the log application 22a of this change of the API call (Step S167). That is, the change notification unit 31 performs an observer notification.

Then, the log storage unit 32 stores the changes of the API call notified at Step S167 as the log 91 (Step S168).

When the API call performed at Step S161 is not determined to be under the category indicated in the log-target-category information 23 at Step S166, the change notification unit 31 does not notify the log application 22a of this change of the API call. Thus, this change of the API call is not stored as the log 91.

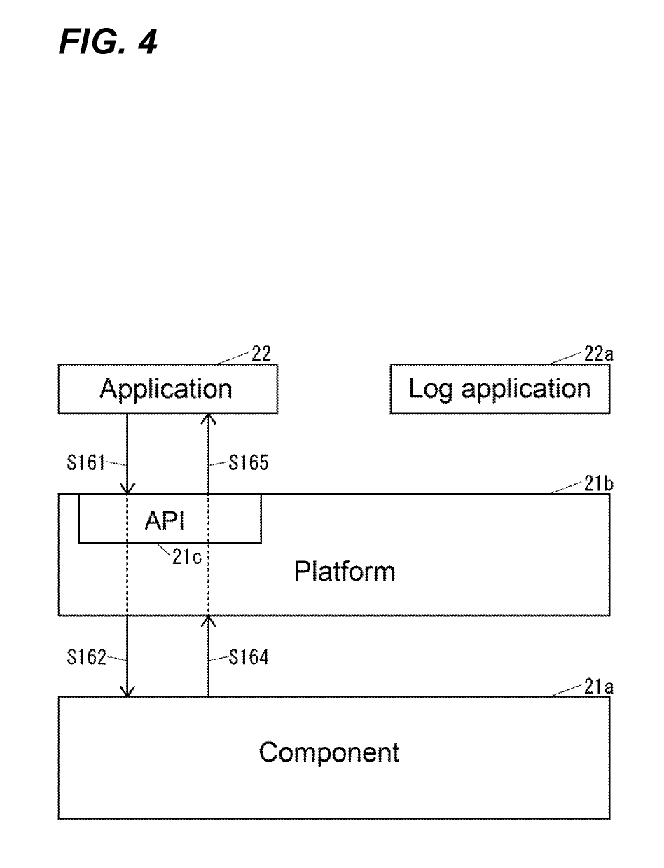

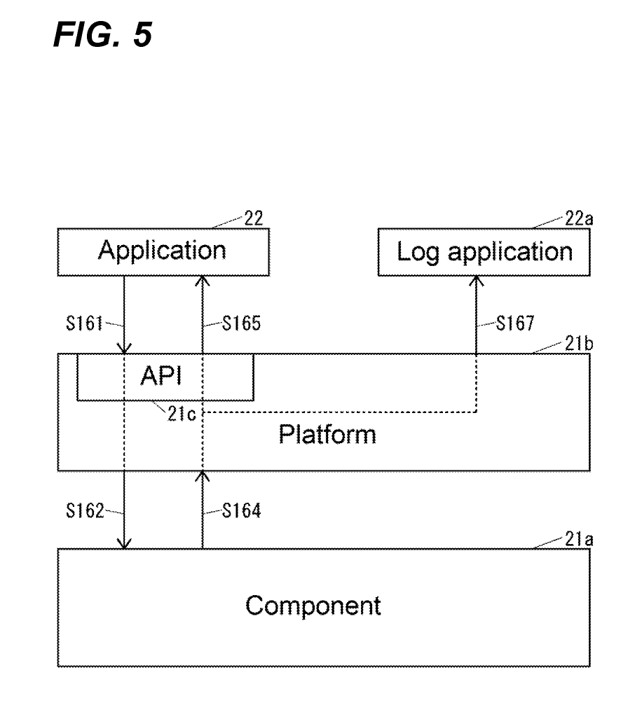

That is, when the API call performed by the application 22 is not under the category indicated in the log-target-category information 23, as illustrated in FIG. 4, the platform 21b performs conventional information exchanges between the application 22 and the component 21a. When the API call performed by the application 22 is under the category indicated in the log-target-category information 23, as illustrated in FIG. 5, the platform 21b not only performs conventional information exchanges between the application 22 and the component 21a but also notifies the log application 22a of the change of the API call.

Even when the change of the API call, which is not under the category indicated in the log-target-category information 23, is notified, the log storage unit 32 does not store this change as the log 91.

After the situation where the failure has occurred, which has been inquired of the user of the MFP 10, is reproduced, the service person analyzes the log 91 stored by the MFP 10 to identify a cause of the failure, so as to eliminate the failure.

After the cause of the failure is specified or similar case, the service person can uninstall the log application 22a from the MFP 10.

As described above, the MFP 10 stores the log 91 as the changes of the internal state in the MFP 10 and the changes of the API call by the application 22. This facilitates identifying the cause of the failure regarding the calling of the API 21c by the application 22.

The MFP 10 stores the changes of the internal state in the MFP 10 and the changes of the API call by the application 22 of only one category to which the log application 22a corresponds as the log 91. This ensures the reduced processing load of storing the log 91. Thus, the MFP 10 ensures the function of storing the log 91 as the changes of the internal state in the MFP 10 and the changes of the API call by the application 22 without hindering the other functions (such as the FAX function, the print function, the sleep function, and a function of storing a log other than the log 91).

The MFP 10 stores the changes of the internal state in the MFP 10 and the changes of the API call by the application 22 of only one category to which the log application 22a corresponds as the log 91, thus reducing the size of the log 91 to facilitate an analysis operation of the log 91 by an operator.

The MFP 10 notifies the log application 22a of the changes of the internal state in the MFP 10 and the changes of the API call by the application 22 of only one category to which the log application 22a corresponds from the platform 21b, thus ensuring the reduced load of the notification from the platform 21b to the log application 22a. Then, the MFP 10 ensures the function of storing the log 91 as the changes of the internal state in the MFP 10 and the changes of the API call by the application 22 without hindering the functions other than the function.

The MFP 10 does not store the log 91 as the changes of the internal state in the MFP 10 and the changes of the API call by the application 22, in the storage devices (such as the storage unit 20 and the RAM of the control unit 30), which are internally included in the MFP 10 and are used by the functions other than the function of storing the log 91 as the changes of the internal state in the MFP 10 and the changes of the API call by the application 22. This ensures the function of storing the log 91 as the changes of the internal state in the MFP 10 and the changes of the API call by the application 22 without hindering the functions other than the function.

When the MFP 10 writes the information in the external storage device 90, the speed of writing the information is typically slow compared with a case where the MFP 10 writes the information in the internal storage device. However, in the first place, an information amount of being written in the log 91 in one writing is small, and also writing frequency is not so much. This enables the MFP 10 to appropriately store the log 91 even when the log 91 is stored in the external storage device 90.

The MFP 10 may store the log of the changes of the internal state in the MFP 10 and the changes of the API call by the application 22 in the storage device inside the MFP 10.

As described above, in this example, the changes of the internal state in the MFP 10 and the changes of the API call of only one category among the plurality of categories are stored as the log 91. When the service person desires to store changes of internal states in the MFP 10 and changes of API calls of the plurality of categories as the log 91, it is only necessary to install the log application 22a for each category, which the service person desires to store as the log 91, in the MFP 10. For example, when the service person desires to store: the changes of the internal state in the MFP 10 and the changes of the API call of the job-execution-related category; and the changes of the internal state in the MFP 10 and the changes of the API call of the login-related category as the log 91, it is only necessary to install: the log application 22a for the job-execution-related category; and the log application 22a for the login-related category in the MFP 10.

While in the embodiment the electronic device of the disclosure is an MFP, the electronic device may be an image forming apparatus other than an MFP, such as a printer-only machine or a copy-only machine, or may be an electronic device other than an image forming apparatus, such as a Personal Computer (PC).

### EMBODIMENT EXAMPLES OF THE DISCLOSURE

An electronic device of the disclosure is an electronic device including a platform that provides an application program interface (API). The API is called by an application. The electronic device includes a log application for storing a log of: changes of an internal state in the electronic device; and changes of an API call as a calling of the API by the application. The platform causes the electronic device to achieve a change notification unit. The change notification unit notifies the log application of the changes of the internal state and the changes of the API call. The changes of the internal state and the changes of the API call are classified in a plurality of categories. The log application causes the electronic device to achieve a log storage unit. The log storage unit stores the changes of the internal state and the changes of the API call as the log. The changes of the internal state and the changes of the API call are notified by the change notification unit. The log storage unit stores the changes of the internal state and the changes of the API call of only one category among the plurality of categories as the log.

With this configuration, the electronic device of the disclosure stores the log of the changes of the internal state in the electronic device and the changes of the API call by the application. This facilitates identifying the cause of the failure regarding the calling of the API by the application.

In the electronic device of the disclosure, the change notification unit may notify the log application of the change of the internal state and the change of the API call of only the one category.

With this configuration, the electronic device of the disclosure notifies the log application of the change of the internal state in the electronic device and the change of the API call by the application of only one category to which the log application corresponds from the platform, thus ensuring the reduced load of the notification from the platform to the log application. Then, the electronic device of the disclosure ensure the function of storing the log of the changes of the internal state in the electronic device and the changes of the API call by the application without hindering functions other than this function.

In the electronic device of the disclosure, the log storage unit may store the log in a storage device outside the electronic device.

With this configuration, the electronic device of the disclosure does not store the log of the changes of the internal state in the electronic device and the changes of the API call by the application in the storage devices, which are internally included in the electronic device and are used by the functions other than the function of storing the log of the changes of the internal state in the electronic device and the changes of the API call by the application. This ensures the function of storing the log of the changes of the internal state in the electronic device and the changes of the API call by the application without hindering the functions other than the function.

A log application of the disclosure is a log application for storing a log of: changes of an internal state in an electronic device; and changes of an API call as a calling of an API by an application. The electronic device includes a platform that provides the application program interface (API). The API is called by the application. The changes of the internal state and the changes of the API call are classified in a plurality of categories. The log application causes the electronic device to achieve a log storage unit. The log storage unit stores the changes of the internal state and the changes of the API call as the log. The changes of the internal state and the changes of the API call are notified by the platform. The log storage unit stores the changes of the internal state and the changes of the API call of only one category among the plurality of categories as the log.

With this configuration, the electronic device, which executes the log application of the disclosure, stores the log of the changes of the internal state in the electronic device and the changes of the API call by the application. This facilitates identifying the cause of the failure regarding the calling of the API by the application.

### ADVANTAGEOUS EFFECTS OF THE DISCLOSURE

The electronic device and the log application of the disclosure are configured to facilitate identifying the cause of the failure regarding the calling of the API by the application.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An electronic device including a platform that provides an application program interface (API), the API being called by an application, the electronic device comprising:
a recording medium storing a log application that stores a log of
changes of an internal state in the electronic device, and
changes of an API call as a calling of the API by the application; wherein
the platform causes the electronic device to achieve a change notification unit, the change notification unit notifying the log application of the changes of the internal state and the changes of the API call;
the changes of the internal state and the changes of the API call are classified in a plurality of categories;
the log application causes the electronic device to achieve a log storage unit, the log storage unit storing the changes of the internal state and the changes of the API call as the log, the changes of the internal state and the changes of the API call being notified by the change notification unit; and
the log storage unit stores the changes of the internal state and the changes of the API call of only one category among the plurality of categories as the log.

2. The electronic device according to claim 1, wherein the change notification unit notifies the log application of the change of the internal state and the change of the API call of only the one category.

3. The electronic device according to claim 1, wherein the log storage unit stores the log in a storage device outside the electronic device.

4. A non-transitory computer-readable recording medium storing a log application to control an electronic device, the log application causing the electronic device to store a log of:
changes of an internal state in an electronic device, the electronic device including a platform that provides an application program interface (API), the API being called by an application; and
changes of an API call as a calling of the API by the application, wherein
the changes of the internal state and the changes of the API call are classified in a plurality of categories;
the log application causes the electronic device to achieve a log storage unit, the log storage unit storing the changes of the internal state and the changes of the API call as the log, the changes of the internal state and the changes of the API call being notified by the platform; and
the log storage unit stores the changes of the internal state and the changes of the API call of only one category among the plurality of categories as the log.
